(19) United States
(12) Patent Application Publication
(10) Pub. No.: US 2025/0369529 A1
(43) Pub. Date: Dec. 4, 2025

(54) PRESSURE REDUCTION VALVE AND PRODUCTION METHOD FOR PRESSURE REDUCTION VALVE

(71) Applicant: Hitachi Astemo, Ltd., Hitachinaka-shi, Ibaraki (JP)

(72) Inventor: Tomoyoshi KOYAMA, Hitachinaka-shi (JP)

(21) Appl. No.: 18/873,873

(22) PCT Filed: Dec. 27, 2022
(86) PCT No.: PCT/JP2022/048076

§ 371 Date: Dec. 11, 2024

(51) Int. Cl. F16K 25/04; F16K 1/36; F16K 1/46; F16K 27/02

(52) U.S. Cl. CPC F16K 25/04; F16K 1/36; F16K 27/02; F16K 1/465

(57) ABSTRACT

A pressure reduction valve includes: a body member that has an internal space for accommodating a valve element and has a body opening portion communicating with the internal space; a bottom wall surface-forming member that is accommodated in the internal space, is in contact with an inner wall surface of the body member, and forms a bottom wall surface of a valve chamber in which the valve element is located; and a cap member that is screwed to the body member and closes the body opening portion.

### TECHNICAL FIELD

The present invention relates to a pressure reduction valve and a production method for a pressure reduction valve.

### BACKGROUND ART

For example, Patent Document 1 discloses a pressure reduction valve that reduces the pressure of a high-pressure fluid. The pressure reduction valve disclosed in Patent Document 1 includes a pressing member fixed to the inside of a body and a collar member that is displaceably inserted into an insertion hole provided in the pressing member. In addition, the pressure reduction valve includes a spring that is located between the collar member and a valve element. Such a pressure reduction valve is capable of adjusting the pressure of a fluid to be discharged by adjusting the position of the collar member.

### CITATION LIST

### Patent Document

Patent Document 1: Japanese Unexamined Patent Application, First Publication No. 2016-71429

### SUMMARY OF INVENTION

### Technical Problem

In the pressure reduction valve disclosed in Patent Document 1, an upper surface of the collar member forms a bottom wall surface of a valve chamber in which the valve element is accommodated. In addition, the above-described pressing member is located such that a part thereof is exposed inside the valve chamber. In such Patent Document 1, both a boundary surface between the collar member and the pressing member and a boundary surface between the pressing member and the body are connected to the valve chamber. Therefore, there is a possibility that metal powder generated at the boundary surface between the collar member and the pressing member and metal powder generated at the boundary surface between the pressing member and the body are mixed into a flow passage for the fluid, such as the valve chamber or the like. In particular, in a case where the collar member and the pressing member are connected by a screw structure or in a case where the pressing member and the body are connected by a screw structure, metal powder is likely to be generated.

The present invention has been made in view of the above-described problems, and an object of the present invention is to make it possible to suppress mixing of metal powder into a flow passage in a pressure reduction valve.

### Solution to Problem

A first aspect of the present invention employs a configuration in which a pressure reduction valve includes: a body member that has an internal space which accommodates a valve element and has a body opening portion communicating with the internal space; a bottom wall surface-forming member configured to be accommodated in the internal space, be in contact with an inner wall surface of the body member, and form a bottom wall surface of a valve chamber in which the valve element is located; and a cap member configured to be screwed to the body member and close the body opening portion.

A second aspect of the present invention employs a configuration in which a production method for a pressure reduction valve, in which a body member has an internal space which accommodates a valve element and a body opening portion communicates with the internal space, includes: a bottom wall surface-forming member disposing step of accommodating a bottom wall surface-forming member in the internal space such that the bottom wall surface-forming member is in contact with an inner wall surface of the internal space, the bottom wall surface-forming member forming a bottom wall surface of a valve chamber in which the valve element is located; and a sealing step of screwing a cap member, which closes the body opening portion, to the body member.

### Advantageous Effects of Invention

In the present invention, the cap member is screwed to the body member outside the valve chamber. Therefore, a boundary surface between the cap member and the body member is not connected to the valve chamber. Therefore, even in a case where metal powder is generated at the boundary surface between the cap member and the body member, the metal powder generated at the boundary surface is not mixed into the inside of the valve chamber. Therefore, in the pressure reduction valve according to the present invention, it is possible to suppress the mixing of the metal powder into the flow passage.

### BRIEF DESCRIPTION OF DRAWINGS

FIG. 1 A cross-sectional view schematically showing a schematic configuration of a pressure reduction valve according to a first embodiment of the present invention.

FIG. 2 A schematic enlarged view including a valve chamber included in the pressure reduction valve according to the first embodiment of the present invention.

FIG. 3 An exploded perspective view schematically showing a body member, a bottom wall surface-forming member, and a cap member included in the pressure reduction valve of the first embodiment of the present invention.

FIG. 4 A schematic view showing a production method for a pressure reduction valve according to the first embodiment of the present invention.

FIG. 5 A schematic view showing the production method for a pressure reduction valve according to the first embodiment of the present invention.

FIG. 6 A schematic perspective view of a screwing tool used in the production method for a pressure reduction valve according to the first embodiment of the present invention.

FIG. 7 A schematic view showing the production method for a pressure reduction valve according to the first embodiment of the present invention.

FIG. 8 A schematic view showing the production method for a pressure reduction valve according to the first embodiment of the present invention.

FIG. 9 A schematic perspective view of a bottom wall surface-forming member included in a pressure reduction valve according to a second embodiment of the present invention.

### DESCRIPTION OF EMBODIMENTS

Hereinafter, an embodiment of a pressure reduction valve and a production method for the pressure reduction valve according to the present invention will be described with reference to the drawings.

### First Embodiment

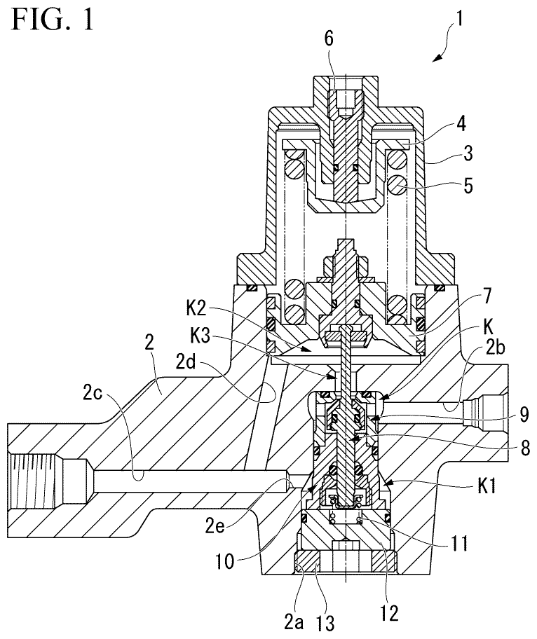

FIG. 1 is a cross-sectional view schematically showing a schematic configuration of a pressure reduction valve 1 of the present embodiment. The pressure reduction valve 1 of the present embodiment is mounted on, for example, a fuel cell vehicle (FCV). The pressure reduction valve 1 reduces the pressure of, for example, a high-pressure hydrogen gas stored in a hydrogen tank to a set pressure. However, the pressure reduction valve of the present invention is not limited to a hydrogen pressure reduction valve that reduces the pressure of hydrogen gas. The pressure reduction valve of the present invention can be applied to a pressure reduction valve that reduces the pressure of a fluid.

As shown in FIG. 1, the pressure reduction valve 1 of the present embodiment includes a body member 2, an upper cover member 3, an upper retainer 4, an upper spring 5, an adjustment screw 6, a piston 7, a valve element 8, a valve seat 9, a guide 10, a lower spring 11 (elastic member), a bottom wall surface-forming member 12, and a cap member 13.

The body member 2 is formed of an aluminum alloy or the like, and is formed by, for example, die casting. The body member 2 is a hollow member having an internal space K. The body member 2 accommodates the upper retainer 4, the upper spring 5, the adjustment screw 6, the piston 7, the valve element 8, the valve seat 9, the guide 10, the lower spring 11, and the bottom wall surface-forming member 12.

As shown in FIG. 1, the internal space K of the body member 2 includes a valve chamber K1, a pressure reduction chamber K2, and a communication hole K3. That is, the body member 2 has the valve chamber K1, the pressure reduction chamber K2, and the communication hole K3 inside. The valve chamber K1 is located below the pressure reduction chamber K2 and accommodates the valve element 8 and the like. The pressure reduction chamber K2 is located above the valve chamber K1 and accommodates the piston 7. The fluid supplied to the pressure reduction chamber K2 is pressure-reduced in the pressure reduction chamber K2. The communication hole K3 connects the valve chamber K1 and the pressure reduction chamber K2.

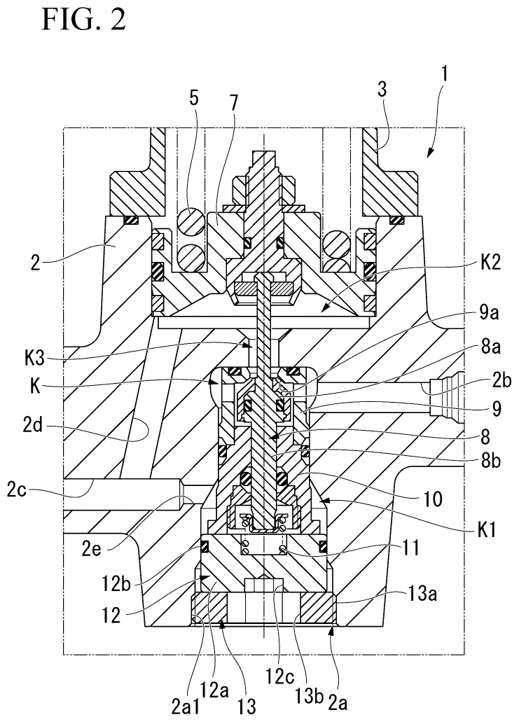

FIG. 2 is a schematic enlarged view including the valve chamber K1. As shown in FIG. 2, the body member 2 has a body opening portion 2a that communicates with the internal space K. The body opening portion 2a is formed at a bottom portion of the body member 2. The body opening portion 2a is formed to penetrate the bottom portion of the body member 2 in an up-down direction. The body opening portion 2a has a female screw 2a1 formed on an inner wall surface thereof. The cap member 13 is screwed to the female screw 2a1 formed on the inner wall surface of the body opening portion 2a. That is, the body opening portion 2a is sealed by the cap member 13.

In addition, as shown in FIG. 1, the body member 2 has a supply flow passage 2b, a discharge flow passage 2c, a first connection flow passage 2d, and a second connection flow passage 2e. The supply flow passage 2b, the discharge flow passage 2c, the first connection flow passage 2d, and the second connection flow passage 2e form a part of an internal flow passage that guides the fluid to be pressure-reduced by the pressure reduction valve 1 of the present embodiment. The valve chamber K1, the pressure reduction chamber K2, and the communication hole K3 are also a part of the internal flow passage that guides the fluid.

The supply flow passage 2b is a flow passage connected to the valve chamber K1 in the horizontal direction. The supply flow passage 2b guides the high-pressure fluid supplied from the outside toward the valve chamber K1. That is, the high-pressure fluid supplied from the outside flows into the valve chamber K1 through the supply flow passage 2b. The discharge flow passage 2c is a flow passage for discharging the fluid pressure-reduced by the pressure reduction valve 1 of the present embodiment to the outside of the pressure reduction valve 1. The supply flow passage 2b is connected to the pressure reduction chamber K2 through a first connection flow passage 2d. The first connection flow passage 2d is a flow passage that connects the pressure reduction chamber K2 and the discharge flow passage 2c. The second connection flow passage 2e is a flow passage that connects the discharge flow passage 2c and the valve chamber K1.

The upper cover member 3 is a cover member that covers the pressure reduction chamber K2 from above. The upper cover member 3 is fastened to, for example, an upper portion of the body member 2 by a bolt (not shown) or the like. In addition, a female screw may be formed on an outer wall surface of the body member 2, and the upper cover member 3 may be screwed to the female screw. The upper cover member 3 forms a space for accommodating the upper retainer 4, the upper spring 5, and the piston 7 between the upper cover member 3 and the body member 2. In addition, the upper cover member 3 has an insertion hole through which the adjustment screw 6 is inserted.

The upper retainer 4 is accommodated in a space formed between the body member 2 and the upper cover member 3. The upper retainer 4 is located above the upper spring 5 and is in contact with an upper end of the upper spring 5 from above. In addition, a lower end of the adjustment screw 6 is in contact with the upper retainer 4 from above. Such an upper retainer 4 is sandwiched between the adjustment screw 6 and the upper spring 5. The upper retainer 4 is moved in the up-down direction according to the position of the lower end of the adjustment screw 6. For example, in a case where the position of the lower end of the adjustment screw 6 is moved upward with respect to a reference position, the upper retainer 4 is moved upward by the biasing force of the upper spring 5. In addition, in a case where the position of the lower end of the adjustment screw 6 is moved downward from the reference position, the upper retainer 4 is moved downward so as to compress the upper spring 5.

The upper spring 5 is accommodated in the space formed between the body member 2 and the upper cover member 3. The upper spring 5 has its upper end in contact with the upper retainer 4 from below and its lower end in contact with the piston 7 from above. The upper spring 5 biases the piston 7 downward.

The adjustment screw 6 is provided to penetrate the upper cover member 3, and has its lower end in contact with the upper retainer 4 from above. The adjustment screw 6 is screwed to the upper cover member 3. The adjustment screw 6 travels in the up-down direction with respect to the upper cover member 3 such that the lower end thereof moves in the up-down direction by rotating the adjustment screw 6.

The piston 7 is accommodated in the space formed between the body member 2 and the upper cover member 3. The piston 7 is located below the upper spring 5. The piston 7 has a cylindrical main body portion and a piston ring fitted to a peripheral surface of the main body portion. The piston 7 is accommodated in the internal space K of the body member 2 such that the piston ring is in contact with an inner wall surface of the body member 2. Such a piston 7 is movable in the up-down direction in the internal space K of the body member 2. The pressure reduction chamber K2 is formed below the piston 7. The volume of the pressure reduction chamber K2 is changed by the piston 7 being moved in the up-down direction.

The valve element 8 includes a valve element body 8a and a valve shaft 8b. The valve element body 8a is located at a center portion of the valve element 8 in the up-down direction, and is provided to protrude outward in a radial direction of the valve shaft 8b with respect to the valve shaft 8b. The valve element body 8a is capable of being in contact with and being spaced apart from the valve seat 9. The flow passage for the fluid is closed by the valve element body 8a being in contact with the valve seat 9. That is, the fluid can flow through the flow passage by the valve element body 8a being spaced apart from the valve seat 9.

The valve shaft 8b is a rod portion that linearly extends in the up-down direction. The valve shaft 8b supports the valve element body 8a at an intermediate portion in the up-down direction. An upper end portion of the valve shaft 8b is fixed to the piston 7. In addition, a lower end portion of the valve shaft 8b is connected to the lower spring 11.

Such a valve element 8 is formed such that the valve element body 8a and the valve shaft 8b are integrated with each other. As shown in FIGS. 1 and 2, the valve element 8 is accommodated in the internal space K of the body member 2. In addition, the valve element body 8a is located in the valve chamber K1. That is, the valve chamber K1 has the valve element 8 located therein.

The valve seat 9 is accommodated in an upper portion of the valve chamber K1. In the present embodiment, the valve seat 9 is formed in a cylindrical shape having an upper wall and a peripheral wall. The valve seat 9 has a plurality of through-holes that penetrate the peripheral wall in the horizontal direction. The fluid is capable of flowing from the outside to the inside of the valve seat 9 through the through-holes provided in the peripheral wall. In addition, the valve seat 9 has a through-hole that penetrates the upper wall in the up-down direction. The through-hole provided in the upper wall is connected to the communication hole K3. The fluid is capable of flowing out from the inside to the outside of the valve seat 9 through the through-hole provided in the upper wall. The fluid that has flowed out from the through-hole provided in the upper wall is supplied to the pressure reduction chamber K2 through the communication hole K3.

The valve seat 9 has a valve seat 9a formed to surround the through-hole that penetrates the upper wall in the up-down direction. The valve seat 9a is a portion that is capable of being in contact with the valve element body 8a of the valve element 8. As the valve element body 8a is in contact with the valve seat 9a, the flow passage for the fluid is closed.

The guide 10 is accommodated in the valve chamber K1 and is located below the valve seat 9. The guide 10 is formed in a cylindrical shape having a central opening, and an outer peripheral surface thereof is in contact with an inner wall surface of the valve chamber K1. The valve shaft 8b of the valve element 8 is inserted into the central opening of the guide 10 so as to be movable in the up-down direction. The guide 10 guides the movement of the valve element 8 in the up-down direction.

The lower spring 11 is interposed between the valve element 8 and the bottom wall surface-forming member 12. The upper end of the lower spring 11 is in contact with the valve shaft 8b of the valve element 8 from below. In addition, a lower end of the lower spring 11 is in contact with the bottom wall surface-forming member 12 from above. Such a lower spring 11 biases the valve element 8 upward.

The bottom wall surface-forming member 12 is accommodated in the internal space K of the body member 2 and is located below the valve element 8. The bottom wall surface-forming member 12 forms a bottom wall surface of the valve chamber K1. The bottom wall surface-forming member 12 includes a collar member 12a and a seal ring 12b.

The collar member 12a is formed in a cylindrical shape, and an upper surface thereof is a bottom wall surface of the valve chamber K1. That is, the collar member 12a forms the bottom wall surface of the valve chamber K1. In addition, a recessed portion for accommodating the lower spring 11 is formed on the upper surface of the collar member 12a.

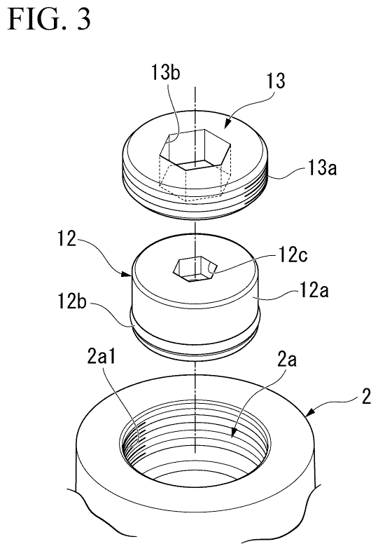

FIG. 3 is an exploded perspective view schematically showing the body member 2, the bottom wall surface-forming member 12, and the cap member 13. In FIG. 3, the up and down are reversed. That is, the upper side in FIG. 3 is the lower side of the pressure reduction valve 1, and the lower side in FIG. 3 is the upper side of the pressure reduction valve 1. As shown in FIG. 3, a polygonal recessed portion 12c (tool connecting portion) is provided at a bottom portion of the collar member 12a.

The polygonal recessed portion 12c is located at a center portion of a circular bottom portion of the collar member 12a. The polygonal recessed portion 12c is a recessed portion formed in a polygonal shape as viewed from below. The polygonal recessed portion 12c is a tool connecting portion into which a rotation regulating tool 200, which will be described below, is inserted. The cap member 13 has an opening portion 13b described below. The polygonal recessed portion 12c is provided at a portion exposed by the opening portion 13b of the cap member 13. Such a polygonal recessed portion 12c is a polygonal recessed portion as viewed in a through-direction of the opening portion 13b.

The seal ring 12b is a seal member attached to the peripheral surface of the collar member 12a. The seal ring 12b is interposed between the collar member 12a and the inner wall surface of the body member 2, and prevents a fluid from flowing between the collar member 12a and the inner wall surface of the body member 2. The seal ring 12b is pressed against the inner wall surface of the body member 2, but is slidable with respect to the inner wall surface of the body member 2 by applying a strong force in the up-down direction. That is, the seal ring 12b is slidably in contact with the inner wall surface of the body member 2.

Such a bottom wall surface-forming member 12 is accommodated in the internal space of the body member 2 and is in contact with the inner wall surface of the body member 2. In addition, the bottom wall surface-forming member 12 forms the bottom wall surface of the valve chamber K1 in which the valve element 8 is located. In addition, the bottom wall surface-forming member 12 is slidably in contact with the inner wall surface of the body member 2.

The cap member 13 is a member formed in a disk shape. As shown in FIG. 2, the cap member 13 is attached to the body member 2 so as to close the body opening portion 2a of the body member 2. A male screw 13a is provided on a peripheral surface of the cap member 13. The cap member 13 is screwed to the body member 2 by the male screw 13a being engaged with the female screw 2a1 of the body member 2. That is, the cap member 13 is screwed to the body member 2 to close the body opening portion 2a.

As shown in FIG. 2, the cap member 13 is in contact with the bottom wall surface-forming member 12 from below. That is, the cap member 13 is in contact with the collar member 12a from a side opposite to the upper surface (surface forming the bottom wall surface of the valve chamber K1) of the collar member 12a. Such a cap member 13 defines the position of the bottom wall surface-forming member 12 in the up-down direction in the internal space K of the body member 2. That is, in the present embodiment, the cap member 13 functions as a positioning member of the bottom wall surface-forming member 12.

As shown in FIG. 2, the cap member 13 is located below the bottom wall surface-forming member 12. That is, the cap member 13 is located below the bottom wall surface of the valve chamber K1. Therefore, in the present embodiment, a boundary portion (a portion where the female screw 2a1 and the male screw 13a are engaged with each other) between the cap member 13 and the body member 2 is located outside the valve chamber K1. Therefore, even in a case where metal powder is generated at the boundary portion between the cap member 13 and the body member 2, the metal powder is not mixed into the valve chamber K1.

As shown in FIG. 3, the cap member 13 has the opening portion 13b that penetrates in the up-down direction. The opening portion 13b is provided at a center portion of the circular cap member 13. The opening portion 13b is formed to have a size such that the entire polygonal recessed portion 12c of the bottom wall surface-forming member 12 can be exposed. That is, in the present embodiment, the cap member 13 has the opening portion 13b that penetrates the cap member 13 and exposes a part of the bottom wall surface-forming member 12.

In addition, the opening portion 13b is formed in a polygonal shape as viewed from below. That is, the opening portion 13b is formed in a polygonal shape as viewed in a direction along the through-direction. The opening portion 13b is a portion to which a screwing tool 100 described below is attached. The cap member 13 is screwed to the cap member 13 by rotating the screwing tool 100 attached to the opening portion 13b.

Such a pressure reduction valve 1 of the present embodiment discharges the high-pressure fluid (for example, high-pressure hydrogen gas) supplied from the supply flow passage 2b through the discharge flow passage 2c by reducing the pressure to a predetermined pressure. The fluid supplied from the outside to the supply flow passage 2b is guided to the supply flow passage 2b and flows into the valve chamber K1 of the body member 2. The fluid flowing into the valve chamber K1 is supplied to the pressure reduction chamber K2 through the communication hole K3 and is pressure-reduced. The fluid pressure-reduced in the pressure reduction chamber K2 is guided to the discharge flow passage 2c through a first connection flow passage 2d. The fluid guided to the discharge flow passage 2c is discharged from the discharge flow passage 2c to the outside of the pressure reduction valve 1. In addition, a part of the fluid flows between the valve chamber K1 and the discharge flow passage 2c through a second connection flow passage 2e.

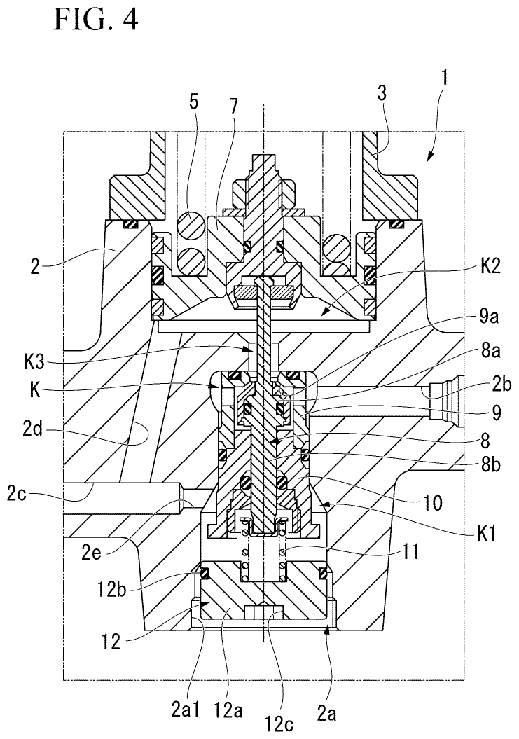

Subsequently, a production method for the pressure reduction valve 1 according to the present embodiment will be described with reference to FIGS. 4 to 8. The pressure reduction valve 1 of the present embodiment is produced by assembling the body member 2, the upper cover member 3, the upper retainer 4, the upper spring 5, the adjustment screw 6, the piston 7, the valve element 8, the valve seat 9, the guide 10, the lower spring 11, the bottom wall surface-forming member 12, and the cap member 13. Here, among these, a step of attaching the bottom wall surface-forming member 12 and the cap member 13, which are characteristic, to the body member 2 will be described.

In addition, in FIGS. 4 to 8, similarly to FIG. 1, the body opening portion 2a of the body member 2 is shown in a posture in which the body opening portion 2a is directed downward. However, in the actual assembly work, the work can be performed in a state where the body opening portion 2a of the body member 2 is directed upward.

In the production method for the pressure reduction valve 1 of the present embodiment, as shown in FIG. 4, the bottom wall surface-forming member 12 is disposed in the internal space K of the body member 2 in a state where the cap member 13 is not attached to the body member 2. Here, the bottom wall surface-forming member 12 is inserted into the internal space K of the body member 2 from the body opening portion 2a. In addition, the bottom wall surface-forming member 12 is accommodated in the internal space K in a state where the seal ring 12b is in contact with the inner wall surface of the internal space K.

The step shown in FIG. 4 is a bottom wall surface-forming member disposing step. That is, the bottom wall surface-forming member disposing step is a step of accommodating the bottom wall surface-forming member 12 that forms the bottom wall surface of the valve chamber K1 of which the valve element 8 is located inside, in the internal space K such that the bottom wall surface-forming member 12 is in contact with the inner wall surface of the internal space K.

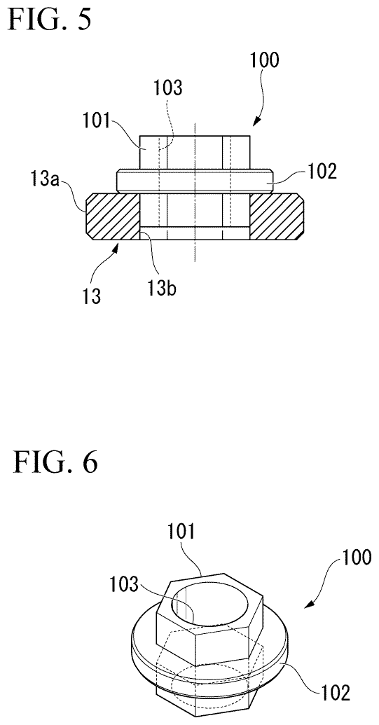

Subsequently, as shown in FIG. 5, the screwing tool 100 is attached to the cap member 13. FIG. 6 is a schematic perspective view of the screwing tool 100. As shown in this figure, the screwing tool 100 includes a tubular portion 101 and a flange portion 102. The tubular portion 101 has a central opening 103. The outer shape of the tubular portion 101 is formed in a polygonal shape having the same number of corners as the opening portion 13b of the cap member 13.

In addition, the tubular portion 101 is insertable into the opening portion 13b and is formed to have a size such that the tubular portion 101 does not idle with respect to the cap member 13 in a case where the tubular portion 101 rotates about an axial center thereof. That is, the cap member 13 is also rotated by rotating the screwing tool 100 in a state where the tubular portion 101 is inserted into the opening portion 13b.

The flange portion 102 is a portion that protrudes from an intermediate portion of the tubular portion 101 toward the outside of the tubular portion 101. The flange portion 102 is a portion that is in contact with a lower surface of the cap member 13 in a case where the tubular portion 101 is inserted into the opening portion 13b of the cap member 13. As the flange portion 102 is in contact with the lower surface of the cap member 13, the screwing tool 100 is positioned with respect to the cap member 13. That is, the screwing tool 100 is attached to the cap member 13 as the tubular portion 101 is inserted into the opening portion 13b and the flange portion 102 is in contact with the lower surface of the cap member 13.

Such a screwing tool 100 has a central opening 103 provided in the tubular portion 101. Such a central opening 103 exposes the polygonal recessed portion 12c of the bottom wall surface-forming member 12 as viewed in the up-down direction in a state where the cap member 13 is attached to the body member 2.

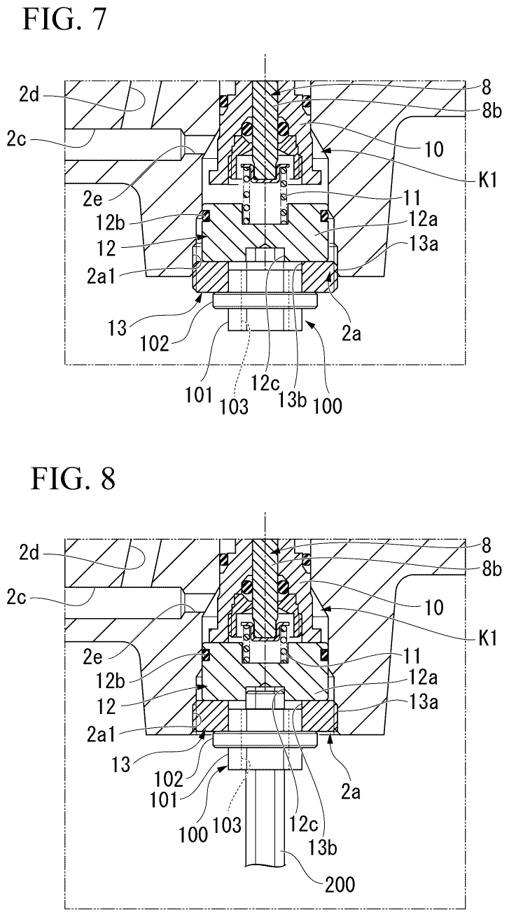

Subsequently, as shown in FIG. 7, the cap member 13 to which the screwing tool 100 is attached is positioned with respect to the body member 2. For example, the cap member 13 is positioned with respect to the body member 2 as the male screw 13a slightly engages with the female screw 2a1 of the body member 2. The screwing tool 100 may be attached to the cap member 13 after the cap member 13 is positioned with respect to the body member 2.

Subsequently, as shown in FIG. 8, the rotation regulating tool 200 is inserted into the polygonal recessed portion 12c of the bottom wall surface-forming member 12, and the cap member 13 is rotated through the screwing tool 100. The rotation regulating tool 200 is a rod-like tool of which at least a tip portion is formed in a polygonal shape having the same number of corners as the polygonal recessed portion 12c. The tip portion of the rotation regulating tool 200 is formed with such a size that the tip portion is insertable into the polygonal recessed portion 12c and does not idle with respect to the bottom wall surface-forming member 12 in a case where the tip portion rotates about the axial center. That is, by pressing the rotation regulating tool 200 such that the rotation regulating tool 200 does not rotate, it is possible to prevent the bottom wall surface-forming member 12 from rotating with the rotation of the cap member 13.

The screwing tool 100 is rotatable by attaching a wrench or the like to the tubular portion 101. By rotating the screwing tool 100, the cap member 13 to which the screwing tool 100 is attached is fastened to the cap member 13. The cap member 13 rotates and travels upward in FIG. 8. That is, the position of the bottom wall surface-forming member 12 can be adjusted by adjusting the tightening amount of the cap member 13 with respect to the body member 2.

As the cap member 13 travels upward, the bottom wall surface-forming member 12 is pressed by the cap member 13 and moves upward. In this case, since the rotation of the bottom wall surface-forming member 12 is regulated by the rotation regulating tool 200, the bottom wall surface-forming member 12 is moved upward without rotating. Therefore, the sliding between the bottom wall surface-forming member 12 and the body member 2 can be minimized.

As the bottom wall surface-forming member 12 is moved upward, the amount of compression of the lower spring 11 interposed between the bottom wall surface-forming member 12 and the valve element 8 increases, and the biasing force applied from the lower spring 11 to the valve element 8 increases. That is, the biasing force of the lower spring 11 to the valve element 8 can be adjusted by adjusting the tightening amount of the cap member 13.

In a case where the adjustment of the tightening amount of the cap member 13 is completed, the body opening portion 2a of the body member 2 is sealed by the cap member 13. That is, the steps shown in FIGS. 5, 7, and 8 are sealing steps of screwing the cap member 13, which closes the body opening portion 2a, to the body member 2.

In the present embodiment, in the sealing step, the position of the bottom wall surface-forming member 12 is adjusted by adjusting the tightening amount of the cap member 13 with respect to the body member 2. In addition, in the sealing step, the cap member 13 is screwed to the body member 2 while connecting the rotation regulating tool 200 to the polygonal recessed portion 12c to regulate the rotation of the bottom wall surface-forming member 12. More specifically, in the sealing step, the screwing tool 100 having the central opening 103 through which the polygonal recessed portion 12c of the collar member 12a is exposed is attached to the opening portion 13b of the cap member 13, the rotation regulating tool 200 is inserted into the polygonal recessed portion 12c through the central opening 103, and the cap member 13 is rotated through the screwing tool 100.

The pressure reduction valve 1 of the present embodiment as described above includes the body member 2, the bottom wall surface-forming member 12, and the cap member 13. The body member 2 has the internal space K that accommodates the valve element 8. In addition, the body member 2 has the body opening portion 2a that communicates with the internal space K. The bottom wall surface-forming member 12 is accommodated in the internal space K and is in contact with the inner wall surface of the body member 2. In addition, the bottom wall surface-forming member 12 forms the bottom wall surface of the valve chamber K1 in which the valve element 8 is located. The cap member 13 is screwed to the body member 2 to close the body opening portion 2a.

In the pressure reduction valve 1 of the present embodiment, the cap member 13 is screwed to the body member 2 outside the valve chamber K1. Therefore, a boundary surface between the cap member 13 and the body member 2 is not connected to the valve chamber K1. Therefore, even in a case where metal powder is generated at the boundary surface between the cap member 13 and the body member 2, the metal powder generated at the boundary surface is not mixed into the inside of the valve chamber K1. Therefore, the pressure reduction valve 1 of the present embodiment can suppress the mixing of the metal powder into the flow passage.

In addition, in the pressure reduction valve 1 of the present embodiment, the bottom wall surface-forming member 12 is slidably in contact with the inner wall surface of the body member 2. In addition, the cap member 13 is in contact with the bottom wall surface-forming member 12 from a side opposite to the surface forming the bottom wall surface. In the pressure reduction valve 1 of the present embodiment, the position of the bottom wall surface-forming member 12 can be adjusted according to the tightening amount of the cap member 13 with respect to the body member 2. Therefore, the pressure reduction valve 1 of the present embodiment can use the cap member 13 as the positioning member of the bottom wall surface-forming member 12.

In addition, the pressure reduction valve 1 of the present embodiment includes the lower spring 11 interposed between the bottom wall surface-forming member 12 and the valve element 8. In the pressure reduction valve 1 of the present embodiment, the position of the bottom wall surface-forming member 12 is adjusted according to the tightening amount of the cap member 13, and the compression amount of the lower spring 11 is further adjusted. Therefore, in the pressure reduction valve 1 of the present embodiment, the biasing force applied to the valve element 8 from the lower spring 11 can be adjusted by adjusting the tightening amount of the cap member 13.

In addition, in the pressure reduction valve 1 of the present embodiment, the cap member 13 has the opening portion 13b that penetrates the cap member 13 and exposes a part of the bottom wall surface-forming member 12. In the pressure reduction valve 1 of the present embodiment, the cap member 13 can be rotated while the cap member 13 is pressed through the opening portion 13b.

In addition, in the pressure reduction valve 1 of the present embodiment, the opening portion 13b is formed in a polygonal shape as viewed from a direction along the through-direction of the opening portion 13b. Therefore, in the pressure reduction valve 1 of the present embodiment, the cap member 13 can be easily rotated by attaching a tool such as the screwing tool 100 or the like to the opening portion 13b.

In addition, in the pressure reduction valve 1 of the present embodiment, the bottom wall surface-forming member 12 includes the polygonal recessed portion 12c provided at a portion exposed through the opening portion 13b. In the pressure reduction valve 1 of the present embodiment, a tool such as the rotation regulating tool 200 or the like is connected to the polygonal recessed portion 12c through the opening portion 13b, so that the rotation of the bottom wall surface-forming member 12 can be easily prevented.

In addition, in the pressure reduction valve 1 of the present embodiment, the polygonal recessed portion 12c is a polygonal recessed portion as viewed in the through-direction of the opening portion 13b. Therefore, in the pressure reduction valve 1 of the present embodiment, the rotation of the bottom wall surface-forming member 12 can be easily prevented by inserting the tip portion of the rotation regulating tool 200 into the polygonal recessed portion 12c.

In addition, in the pressure reduction valve 1 of the present embodiment, the bottom wall surface-forming member 12 includes the collar member 12a and the seal ring 12b. The collar member 12a forms a bottom wall surface. The seal ring 12b is interposed between the collar member 12a and the inner wall surface of the body member 2 and is in contact with the body member 2. In the bottom wall surface-forming member 12, the seal ring 12b is in contact with the inner wall surface of the body member 2. Therefore, in a case where the bottom wall surface-forming member 12 slides on the inner wall surface of the body member 2, the pressure reduction valve 1 of the present invention can suppress the generation of metal powder.

In addition, the production method for the pressure reduction valve 1 of the present embodiment includes the bottom wall surface-forming member disposing step and the sealing step. The bottom wall surface-forming member disposing step is a step of accommodating the bottom wall surface-forming member 12 that forms the bottom wall surface of the valve chamber K1 of which the valve element 8 is located inside, in the internal space K such that the bottom wall surface-forming member 12 is in contact with the inner wall surface of the internal space K. In addition, the sealing step is a step of screwing the cap member 13, which closes the body opening portion 2a, to the body member 2.

In the production method for the pressure reduction valve 1 of the present embodiment, the cap member 13 is screwed to the body member 2 outside the valve chamber K1. Therefore, a boundary surface between the cap member 13 and the body member 2 is not connected to the valve chamber K1. Therefore, even in a case where metal powder is generated at the boundary surface between the cap member 13 and the body member 2, the metal powder generated at the boundary surface is not mixed into the inside of the valve chamber K1. Therefore, the production method for the pressure reduction valve 1 according to the present embodiment can suppress the mixing of the metal powder into the flow passage.

In addition, in the production method for the pressure reduction valve 1 of the present embodiment, in the sealing step, the position of the bottom wall surface-forming member 12 is adjusted by adjusting the tightening amount of the cap member 13 with respect to the body member 2. In the production method for the pressure reduction valve 1 of the present embodiment, the position of the bottom wall surface-forming member 12 can be adjusted according to the tightening amount of the cap member 13 with respect to the body member 2. Therefore, in the production method for the pressure reduction valve 1 according to the present embodiment, the cap member 13 can be used as the positioning member of the bottom wall surface-forming member 12.

In addition, in the production method for the pressure reduction valve 1 of the present embodiment, in the sealing step, the cap member 13 is screwed to the body member 2 while connecting the rotation regulating tool 200 to the polygonal recessed portion 12c to regulate the rotation of the bottom wall surface-forming member 12. Therefore, in the production method for the pressure reduction valve 1 of the present embodiment, in a case where the cap member 13 is screwed to the body member 2, the bottom wall surface-forming member 12 is prevented from rotating, and the sliding between the bottom wall surface-forming member 12 and the body member 2 can be minimized.

In addition, in the production method for the pressure reduction valve 1 of the present embodiment, in the sealing step, the screwing tool 100 having the central opening 103 in which the polygonal recessed portion 12c is exposed is attached to the opening portion 13b of the cap member 13, the rotation regulating tool 200 is inserted into the polygonal recessed portion 12c through the central opening 103, and the cap member 13 is rotated through the screwing tool 100. In the production method for the pressure reduction valve 1 of the present embodiment, in a case where the cap member 13 is screwed into the body member 2, the bottom wall surface-forming member 12 can be easily prevented from rotating, and the sliding between the bottom wall surface-forming member 12 and the body member 2 can be minimized.

### Second Embodiment

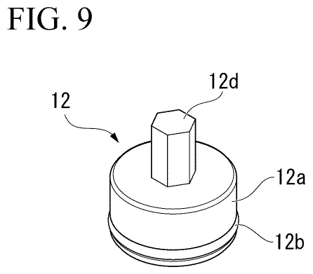

Hereinafter, a second embodiment of the present invention will be described with reference to FIG. 9. In the description of the present embodiment, the description of the same parts as in the first embodiment will be omitted or simplified.

FIG. 9 is a schematic perspective view of a bottom wall surface-forming member 12 included in the pressure reduction valve of the present embodiment. In FIG. 9, the up and down are reversed. As shown in this figure, in the present embodiment, the bottom wall surface-forming member 12 includes a polygonal protruding portion 12d (tool connecting portion) instead of the polygonal recessed portion 12c.

The polygonal protruding portion 12d is located at the center portion of the circular bottom portion of the collar member 12a. The polygonal recessed portion 12c is a protruding portion formed in a polygonal shape as viewed from below. The polygonal protruding portion 12d is a tool connecting portion to which the rotation regulating tool (not shown) is connected.

In the pressure reduction valve of the present embodiment, the tool connecting portion provided in the bottom wall surface-forming member 12 includes the protruding portion. Even in the pressure reduction valve of the present embodiment, the cap member 13 can be screwed to the body member 2 while the rotation regulating tool is connected to the polygonal protruding portion 12d to regulate the rotation of the bottom wall surface-forming member 12. Therefore, in a case where the cap member 13 is screwed into the body member 2, the bottom wall surface-forming member 12 can be prevented from rotating, and the sliding between the bottom wall surface-forming member 12 and the body member 2 can be minimized.

Although the preferred embodiments of the present invention have been described above with reference to the accompanying drawings, it goes without saying that the present invention is not limited to the above embodiments. The various shapes, combinations, and the like of the each constituent member shown in the above-described embodiment are merely examples, and can be variously changed based on design requirements and the like without departing from the gist of the present invention.

For example, in the above-described embodiments, the configuration in which the screwing tool 100 is attached to the cap member 13 has been described. However, the present invention is not limited to this. For example, the screwing tool 100 can be integrated with the cap member 13. In such a case, the tubular portion 101 of the screwing tool 100 is integrated with the cap member 13.

The embodiments described above can also be described as, for example, the following supplementary notes.

### (Supplementary Note 1)

A pressure reduction valve including:
a body member that has an internal space which accommodates a valve element and has a body opening portion communicating with the internal space;
a bottom wall surface-forming member configured to be accommodated in the internal space, be in contact with an inner wall surface of the body member, and form a bottom wall surface of a valve chamber in which the valve element is located; and
a cap member configured to be screwed to the body member and close the body opening portion.

### (Supplementary Note 2)

The pressure reduction valve according to Supplementary Note 1,
in which the bottom wall surface-forming member is slidably in contact with the inner wall surface of the body member, and
the cap member is in contact with the bottom wall surface-forming member from a side opposite to a surface forming the bottom wall surface.

### (Supplementary Note 3)

The pressure reduction valve according to Supplementary Note 2, further including an elastic member interposed between the bottom wall surface-forming member and the valve element.

### (Supplementary Note 4)

The pressure reduction valve according to any one of Supplementary Notes 1 to 3, in which the cap member has an opening portion that penetrates the cap member to expose a part of the bottom wall surface-forming member.

### (Supplementary Note 5)

The pressure reduction valve according to Supplementary Note 4, in which the opening portion is formed in a polygonal shape as viewed in a direction along a through-direction of the opening portion.

### (Supplementary Note 6)

The pressure reduction valve according to Supplementary Note 4 or 5, in which the bottom wall surface-forming member includes a tool connecting portion provided at a portion exposed at the opening portion.

### (Supplementary Note 7)

The pressure reduction valve according to Supplementary Note 6, in which the tool connecting portion is a recessed portion having a polygonal shape as viewed in the through-direction of the opening portion.

### (Supplementary Note 8)

The pressure reduction valve according to any one of Supplementary Notes 1 to 7,
in which the bottom wall surface-forming member includes
a collar member that forms the bottom wall surface, and
a seal ring that is interposed between the collar member and the inner wall surface of the body member and is in contact with the body member.

### (Supplementary Note 9)

A production method for a pressure reduction valve,
in which a body member has an internal space, which accommodates a valve element, and a body opening portion, which communicates with the internal space,
the method including: a bottom wall surface-forming member disposing step of accommodating a bottom wall surface-forming member in the internal space such that the bottom wall surface-forming member is in contact with an inner wall surface of the internal space, the bottom wall surface-forming member forming a bottom wall surface of a valve chamber in which the valve element is located;
and a sealing step of screwing a cap member, which closes the body opening portion, to the body member.

### (Supplementary Note 10)

The production method for a pressure reduction valve according to Supplementary Note 9,
in which the bottom wall surface-forming member is slidably in contact with an inner wall surface of the body member,
the cap member is in contact with the bottom wall surface-forming member from a side opposite to a surface forming the bottom wall surface, and
in the sealing step, a position of the bottom wall surface-forming member is adjusted by adjusting a tightening amount of the cap member with respect to the body member.

### (Supplementary Note 11)

The production method for a pressure reduction valve according to Supplementary Note 9 or 10,
in which the cap member has an opening portion that penetrates the cap member to expose a part of the bottom wall surface-forming member,
the bottom wall surface-forming member has a tool connecting portion provided at a portion exposed at the opening portion, and
in the sealing step, the cap member is screwed to the body member while connecting a rotation regulating tool to the tool connecting portion to regulate rotation of the bottom wall surface-forming member.

### (Supplementary Note 12)

The production method for a pressure reduction valve according to Supplementary Note 11,
in which the opening portion is formed in a polygonal shape as viewed in a direction along a through-direction of the opening portion,
the tool connecting portion is a recessed portion having a polygonal shape as viewed in the through-direction of the opening portion, and
in the sealing step,
a screwing tool having a central opening through which the tool connecting portion is exposed is attached to the opening portion,
a rotation regulating tool is inserted into the tool connecting portion through the central opening, and the cap member is rotated through the screwing tool.

### REFERENCE SIGNS LIST

1 Pressure reduction valve
2 Body member
2a Body opening portion
2a1 Female screw
2b Supply flow passage
2c Discharge flow passage
2d First connection flow passage
2e Second connection flow passage
3 Upper cover member
4 Upper Retainer
5 Upper spring
6 Adjustment screw
7 Piston
8 Valve element
8a Valve element body
8b Valve shaft
9 Valve seat
9a Valve seat
10 Guide
11 Lower spring (elastic member)
12 Bottom wall surface-forming member
12a Collar member
12b Seal ring
12c Polygonal recessed portion (tool connecting portion)
12d Polygonal protruding portion (tool connecting portion)
13 Cap member
13a Male screw
13b Opening portion
100 Screwing tool
101 Tubular portion
102 Flange portion
103 Central opening
200 Rotation regulating tool
K Internal space
K1 Valve chamber
K2 Pressure reduction chamber
K3 Communication hole

1. A pressure reduction valve comprising:
a body member that has an internal space which accommodates a valve element and has a body opening portion communicating with the internal space;
a bottom wall surface-forming member configured to be accommodated in the internal space, be in contact with an inner wall surface of the body member, and form a bottom wall surface of a valve chamber in which the valve element is located; and
a cap member configured to be screwed to the body member and close the body opening portion.

2. The pressure reduction valve according to claim 1, wherein the bottom wall surface-forming member is slidably in contact with the inner wall surface of the body member, and
the cap member is in contact with the bottom wall surface-forming member from a side opposite to a surface forming the bottom wall surface.

3. The pressure reduction valve according to claim 2, further comprising:
an elastic member interposed between the bottom wall surface-forming member and the valve element.

4. The pressure reduction valve according to claim 1,
wherein the cap member has an opening portion that penetrates the cap member to expose a part of the bottom wall surface-forming member.

5. The pressure reduction valve according to claim 4, wherein the opening portion is formed in a polygonal shape as viewed in a direction along a through-direction of the opening portion.

6. The pressure reduction valve according to claim 4, wherein the bottom wall surface-forming member includes a tool connecting portion provided at a portion exposed at the opening portion.

7. The pressure reduction valve according to claim 6, wherein the tool connecting portion is a recessed portion having a polygonal shape as viewed in the through-direction of the opening portion.

8. The pressure reduction valve according to claim 1,
wherein the bottom wall surface-forming member includes
a collar member that forms the bottom wall surface, and
a seal ring that is interposed between the collar member and the inner wall surface of the body member and is in contact with the body member.

9. A production method for a pressure reduction valve, in which a body member has an internal space, which accommodates a valve element, and a body opening portion, which communicates with the internal space, the method comprising:
a bottom wall surface-forming member disposing step of accommodating a bottom wall surface-forming member in the internal space such that the bottom wall surface-forming member is in contact with an inner wall surface of the internal space, the bottom wall surface-forming member forming a bottom wall surface of a valve chamber in which the valve element is located; and
a sealing step of screwing a cap member, which closes the body opening portion, to the body member.

10. The production method for a pressure reduction valve according to claim 9,
wherein the bottom wall surface-forming member is slidably in contact with an inner wall surface of the body member,
the cap member is in contact with the bottom wall surface-forming member from a side opposite to a surface forming the bottom wall surface, and
in the sealing step, a position of the bottom wall surface-forming member is adjusted by adjusting a tightening amount of the cap member with respect to the body member.

11. The production method for a pressure reduction valve according to claim 9,
wherein the cap member has an opening portion that penetrates the cap member to expose a part of the bottom wall surface-forming member,
the bottom wall surface-forming member has a tool connecting portion provided at a portion exposed at the opening portion, and
in the sealing step, the cap member is screwed to the body member while connecting a rotation regulating tool to the tool connecting portion to regulate rotation of the bottom wall surface-forming member.

12. The production method for a pressure reduction valve according to claim 11,
wherein the opening portion is formed in a polygonal shape as viewed in a direction along a through-direction of the opening portion,
the tool connecting portion is a recessed portion having a polygonal shape as viewed in the through-direction of the opening portion, and
in the sealing step,
a screwing tool having a central opening through which the tool connecting portion is exposed is attached to the opening portion,
the rotation regulating tool is inserted into the tool connecting portion through the central opening, and
the cap member is rotated through the screwing tool.

13. The pressure reduction valve according to claim 2,
wherein the cap member has an opening portion that penetrates the cap member to expose a part of the bottom wall surface-forming member.

14. The pressure reduction valve according to claim 3,
wherein the cap member has an opening portion that penetrates the cap member to expose a part of the bottom wall surface-forming member.

15. The pressure reduction valve according to claim 2,
wherein the bottom wall surface-forming member includes
a collar member that forms the bottom wall surface, and
a seal ring that is interposed between the collar member and the inner wall surface of the body member and is in contact with the body member.

16. The pressure reduction valve according to claim 3,
wherein the bottom wall surface-forming member includes
a collar member that forms the bottom wall surface, and
a seal ring that is interposed between the collar member and the inner wall surface of the body member and is in contact with the body member.

17. The production method for a pressure reduction valve according to claim 10,
wherein the cap member has an opening portion that penetrates the cap member to expose a part of the bottom wall surface-forming member,
the bottom wall surface-forming member has a tool connecting portion provided at a portion exposed at the opening portion, and
in the sealing step, the cap member is screwed to the body member while connecting a rotation regulating tool to the tool connecting portion to regulate rotation of the bottom wall surface-forming member.
